(19) United States
(12) Patent Application Publication
(10) Pub. No.: US 2014/0094054 A1
(43) Pub. Date: Apr. 3, 2014

(54) CREDIT CARD SHAPED CHARGING AND DATA CABLE

(71) Applicant: Zeller Design, LLC, Los Angeles, CA (US)

(72) Inventors: Noah M. Dentzel, Santa Barbara, CA (US); Adam C. Miller, Los Angeles, CA (US)

(21) Appl. No.: 13/945,833

(22) Filed: Jul. 18, 2013

Related U.S. Application Data
(60) Provisional application No. 61/674,104, filed on Jul. 20, 2012.

(51) Int. Cl. H01R 13/72; H01R 43/26

(52) U.S. Cl. CPC H01R 13/72; H01R 43/26
USPC 439/501; 29/825

(57) ABSTRACT

A data and charging cable includes a body portion having a form factor substantially like that of a credit card, including a slot extending from a first end of the body portion toward a second end of the body portion. The cable includes an elastomeric tongue having a proximal end pivotably attached to the first end of the body portion and a distal end removably attached to the body portion by a detent mechanism. A first plug is located at the second end of the body portion, with a first set of contacts configured to be inserted into a first electronic device. A second plug is located at the distal end of the tongue, with a second set of contacts configured to be inserted into a second electronic device. A conductive path extending between the first and second sets of contacts is configured to transmit data and electrical power.

### CROSS REFERENCE TO RELATED APPLICATIONS

This application claims priority to co-pending and commonly assigned U.S. Provisional Patent Application No. 61/674,104, filed on Jul. 20, 2012, entitled “A USB CHARGE/SYNC CABLE ROUGHLY THE SIZE/SHAPE OF A STANDARD CREDIT CARD THAT FITS IN THE SLEEVE OF A WALLET. SEMI-RIGID BODY WITH 4 DEGREES OF FREEDOM,” by Dentzel et al. (Attorney Docket No. ZELLP001PROV), which is incorporated herein by reference in its entirety for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates to a credit card shaped cable for charging a device and synchronizing data with a device. A digital-savvy consumer is often in need of a way to charge his mobile devices wherever he is. With the prevalence of USB ports in everyday life, a thin smartphone data and charging cable that fits in your wallet would be quite convenient.

### SUMMARY

The great majority of consumers almost always carry a wallet or a purse capable of holding credit cards. The great majority of consumers also almost always carry a mobile device that runs on a constantly draining battery that may be charged at any USB port with a USB cable. The problem is that while USB ports may be found almost anywhere there is an electronic device, the great majority of consumers do not usually have a USB cable on them to charge their mobile devices. While a typical USB cable is certainly small enough to keep in a bag, it does not possess a shape that makes it pocketable and easy to always have on hand.

Various implementations of the invention resolve this problem by providing a credit-card sized charging cable that can fit in any standard wallet or purse sleeve. In one aspect, the invention features a USB cable having the approximate form factor of a credit card, so that it may easily fit into a wallet. Typically, when a cell phone or other mobile device goes dead, a user does not always have a power cable with him or her, even if an outlet or power source is available. Devices that can charge a mobile device without a power source require special attention to be brought along to where a device might run out of power. Cables tend to be kept attached to a wall or computer, or in a desk drawer, and their shapes are often too cumbersome for the user to easily carry the device with them. Other cables are too thick to fit into the sleeve of most wallets.

Some of the disclosed embodiments of the data and charging cable, with the unique form factor, can fit into the business card slot of a user's purse or wallet; an item which is, by habit, commonly carried by most people nearly all of the time. When one exits the house with their phone, they are sure to have a purse or wallet with them. Embodiments of the claimed invention ensure these users would have a charging solution with them as well.

Various implementations of the invention may include one or more of the following features: a body portion having a form factor substantially like that of a credit card; a slot in the body portion; an elastomeric tongue pivotably attached to one end of the body portion and removably attached at the other end of the body portion to fit in the slot of the body portion; a first plug including a first set of contacts located at the other end of the body portion; a second plug including a second set of contacts located at the distal end of the elastomeric tongue; and a conductive path extending between the first and second sets of contacts, the conductive path configured to transfer data and electrical power between the first and second sets of contacts. The form factor of various implementations of the invention provides a data and charging cable that is small enough to fit in a wallet and long and flexible enough to synchronize data between the first electronic device and the second electronic device and to charge the first electronic device using electrical power from the second electronic device with a charging port.

The body portion of the cable may include a slot extending from proximal to a first end of the body portion along the length of the body portion toward a second end of the body portion and between the upper surface and lower surface of the body portion. In some implementations, the thickness of the body portion does not exceed about 2.6 millimeters. In other implementations, the body portion has a form factor smaller than 121 mm×76 mm×3.8 mm. In some implementations, the body portion has uniform thickness. In other implementations, the body portion may have tapered edges, wherein the thickness of the body portion decreases from a first point proximal to the center of the body portion toward a second point proximal to an edge of the body portion.

In some implementations, the elastomeric tongue is sized to fit within the slot of the body portion and removably attached to the body portion by a detent mechanism, such that the longue is movable through the slot from the upper surface to the lower surface of the body portion. In some implementations, the elastomeric tongue is configured to move with four degrees of freedom, including pitch, yaw, roll, and fore-aft translation. In another implementation, the tongue is configured to move with two degrees of freedom: pitch and fore-aft translation.

In some implementations, the first plug and the first set of contacts are formed as an integral part of the body portion to extend outwardly from the second end of the body portion. In another implementation, where the body portion has a first edge and a second edge opposite the first edge, the first plug may be located at a point along the second end of the body portion, wherein the point is closer to the first edge than the second edge, and wherein the first plug extends outwardly from the point at an angle not parallel to the first and second edges of the body portion. In some implementations, the first plug is slightly thicker than the body portion. In other implementations, the first plug may have a thickness that is substantially the same as the thickness of the body portion. The first plug may be thinner than a standard plug containing the first set of contacts and is adapted to fit into the receptacle of the first electronic device. The first set of contacts may be one of: a mobile device connector, a Micro-USB connector, or similar standard used for mobile devices. In some implementations, the first electronic device is a mobile device, the mobile device being one of: a cell phone, a smartphone, a tablet, a personal digital assistant, a smart watch, a Bluetooth earphone, and a GPS receiver.

In some implementations, the second plug may be thinner than a standard plug containing the second set of contacts and is adapted to fit into the receptacle of the second electronic device.

The second set of contacts may be a USB connector having a thickness that is substantially the same as the thickness of the body portion.

Having a thickness of 2.6 mm or less, embodiments of the claimed invention are overall significantly thinner than other cables on the market. The credit card form factor, combined with the overall thinness allows this data and charging cable to reside in the business or credit card sleeve of a wallet, allowing the cable to become a part of daily routine and almost always available when a mobile devices requires charging.

These and other features and advantages of the present invention will be presented in more detail in the following specification of the invention and the accompanying figures, which illustrate, by way of example, the principles of the invention.

### BRIEF DESCRIPTION OF THE DRAWINGS

The invention may best be understood by reference to the following description taken in conjunction with the accompanying drawings that illustrate specific embodiments of the present invention.

FIG. 1 is a top perspective view of a credit card shaped charging and data cable, showing a first embodiment in a flat configuration.

FIG. 2 is a right-side elevational view of FIG. 1.

FIG. 3 is a front elevational view of FIG. 1.

FIG. 4 is a bottom plane view of FIG. 1.

FIG. 5 is a top perspective view of the first embodiment in a deployed configuration.

FIG. 6 is a top perspective view of a second embodiment of the credit card shaped charging and data cable, illustrated in a flat configuration.

FIG. 7 presents an exploded view of the components of the second embodiment of the credit card shaped charging and data cable.

### DETAILED DESCRIPTION

Reference will now be made in detail to some specific embodiments of the present invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. The present invention may be practiced without some or all of these specific details. In other instances, well known process operations have not been described in detail in order not to unnecessarily obscure the present invention.

Furthermore, techniques and mechanisms of the present invention will sometimes be described in singular form for clarity. However, it should be noted that some embodiments can include multiple iterations of a technique or multiple instantiations of a mechanism unless noted otherwise.

Implementations of the invention may include a body portion having a form factor substantially like that of a credit card. In some implementations, the body portion has a form factor smaller than 121 mm×76 mm×2.6 mm. The thinness of the body portion (2.6 mm or less) makes it practical to fit the data and charging cable into a wallet or a purse sleeve to be used on the go. In some embodiments, the length and width of the body portion may be slightly less than that of an actual credit card, so as to fit better into a purse sleeve or wallet. The body portion may include an upper surface and a lower surface, with a slot extending from near a first end of the body portion partially down the length of the body portion toward a second end of the body portion, and extending between the upper surface and the lower surface of the body portion. (See

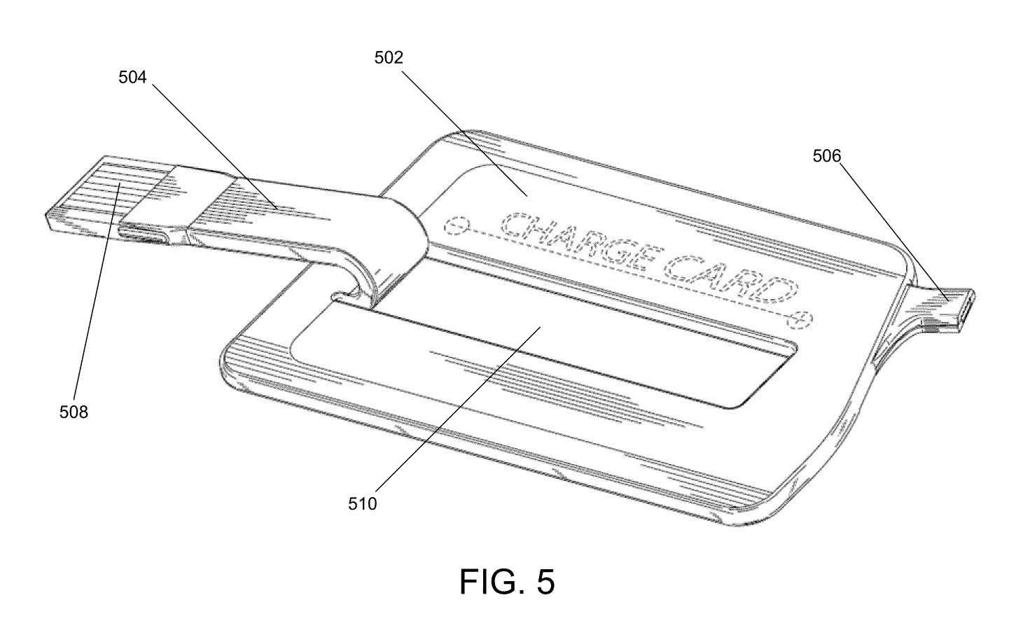

FIG. 5 for example of the slot 510 of the body portion 502).

The slot of the body portion provides a space for accommodating the elastomeric tongue to reside in. To provide a relatively overall flat form factor for the data and charging cable, in some implementations, the thickness of the body portion and the thickness of the elastomeric tongue may be substantially the same. In these implementations, the thinness of the body portion is limited only by the thickness of the elastomeric tongue and the plug and set of contacts located at the distal end of the elastomeric tongue.

Some implementations of the invention may include an embedded battery without increasing the overall thickness of the data and charging cable, wherein one of the connectors is the limiting factor in the minimum thickness of the data and charging cable. In the implementations where the data and charging cable includes a battery, a user of the cable may have the option to charge his mobile device either with the built-in battery, or with the electronic device (such as a computer) that the data and charging cable is plugged into. In some implementations, the cable may automatically access the electronic device, rather than the battery, to charge the mobile device when connected. In these implementations, the embedded battery may be charged when the data and charging cable is connected to the electronic device.

In other implementations, the body portion of the data and charging cable does not include a battery. This implementation may allow the data and charging cable to achieve minimum thickness.

In some implementations, the body portion of the data and charging cable may have tapered edges, wherein the thickness of the body portion decreases from a first point proximal to the center of the body portion toward a second point proximal to an edge of the body portion. In these implementations, the center area of the body portion and the elastomeric tongue may still have a thickness of about 2.6 mm, while the edges of the body portion are thinner because of the tapered edges. This may provide the added advantage of a data and charging cable that is easily slipped in and out of a wallet sleeve.

Implementations of the invention also include an elastomeric tongue having a proximal end and a distal end. The proximal end is pivotably attached to the first end of the body portion in such a way as to permit four degrees of freedom, including pitch, yaw, roll, and fore-aft translation. Because of the flexible nature of the elastomeric tongue, it can be twisted and rotated and moved in and out of the slot while the proximal end of the tongue remains attached to the first end of the body portion. In other implementations of the claimed invention, the elastomeric tongue may be configured to move with two degrees of freedom, including pitch and fore-aft translation.

The tongue is sized to fit within the slot of the body portion, such that the thickness of the card and the thickness of the tongue are substantially the same. In other implementations, the tongue may be thinner than the body portion, so long as it fits within the slot provided in the body portion. In most implementations, however, since overall thinness is a priority in the design of the data and charging cable, and since the second set of contacts at the distal end of the tongue is the limiting factor as to how thin the data and charging cable can be, the body portion will typically be no thicker than the tongue.

In some implementations, the tongue is removably attached to the body portion by a detent mechanism, holding the tongue in place in the slot when not in use. The attachment point may be toward or at the distal end of the tongue, such that the tongue remains substantially within the slot when attached to the body portion by the detent mechanism. In some implementations, the detent mechanism may be hard plastic detents on either side of the distal end of the elastomeric tongue, attaching the distal end of the elastomeric tongue to the body portion toward the second end of the body portion.

The use of a tongue-shaped elastomeric cable may have several advantages. By arranging the wire groupings of the data and charging cable in a flat configuration, the overall thickness of the cable can be lower. Other flat charging cable products that use the typical round wire may not be able to achieve the thinness that is achieved by implementations of the claimed invention.

In some implementations, the tongue is movable through the slot from the upper surface to the lower surface of the body portion. When the tongue is detached from the detent mechanism, it is attached to the body portion only by the proximal end of the tongue, such that the rest of the tongue may freely move in the four degrees of freedom through the slot and in the space above the upper surface of the body portion or the space below the lower surface of the body portion. The flexibility in range of motion allows the data and charging cable to be connected to the mobile device and charging device at various angles and in various locations.

Some implementations of the claimed invention also include a first plug including a first set of contacts located at the second end of the body portion.

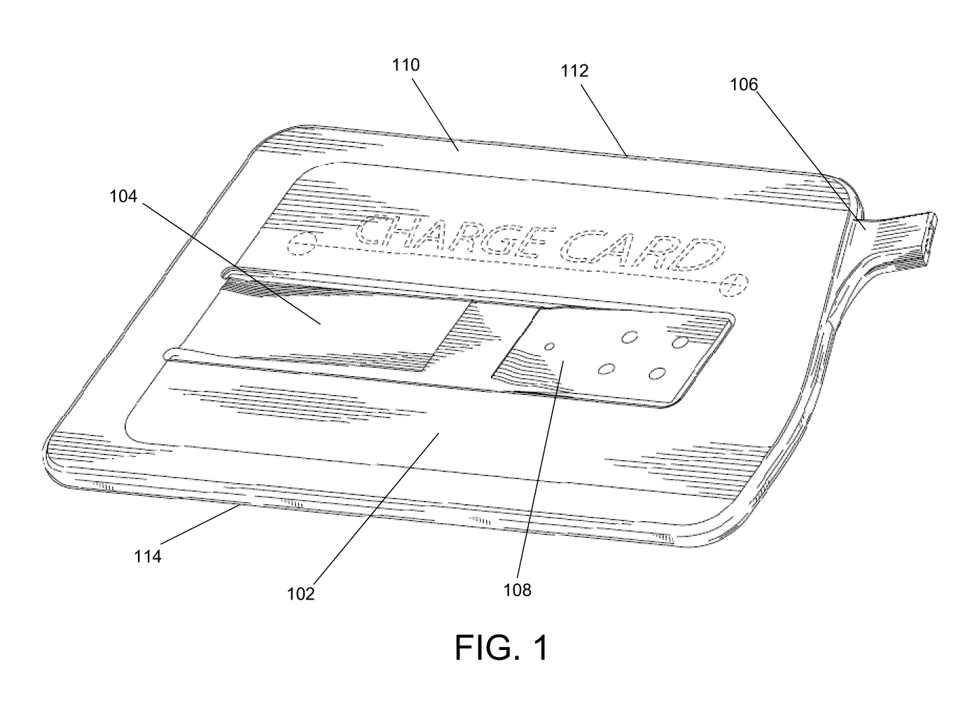

In some implementations, the first plug and the first set of contacts are formed as an integral part of the body portion to extend outwardly from the second end of the body portion. As an example, see FIG. 1. This protruding plug that flares into the body portion allows the first set of contacts to reach the charge port of a mobile device, even if the device is protected by a large case. In some embodiments, the first plug is located toward a corner of the data and charging cable, and in implementations where the first plug is slightly thicker than the body portion, the data and charging cable can still fit neatly into a wallet or purse sleeve.

In some implementations of the claimed invention, the first plug may have a thickness that is substantially the same as the thickness of the body portion. In other implementations, the first plug may be slightly thicker than the body portion. In these cases, the first plug, because of the applicable design specification, may have a minimum thickness that is greater than the body portion, which may have a thickness of 2.6 mm or thinner, depending on the minimal thickness of the second set of contacts at the end of the elastomeric tongue. For example, a Micro USB plug measures about 1.8 mm in thickness, and the shell housing for the Micro USB plug has a minimum thickness of about 0.64 mm on either side, resulting in a total thickness of about 3.0 mm. As another example, the iPhone 5 connector measures about 2.8 mm, and shell housing also has a minimum thickness of about 0.64 mm on either side, resulting in a total thickness of about 4.1 mm. In these examples, the claimed data and charging cables possessing these connectors may have a body and tongue that is roughly the thickness of the second plug, 2.6 mm in the case of standard USB, while the first plug (the Micro USB or iPhone 5 connector) is slightly thicker than the rest of the cable. The extra thickness of the connector portion of the cable, however, does not significantly affect the practicability of fitting the cable into a wallet sleeve or a purse, because the connector is located at the second end of the body portion, rather than in the middle.

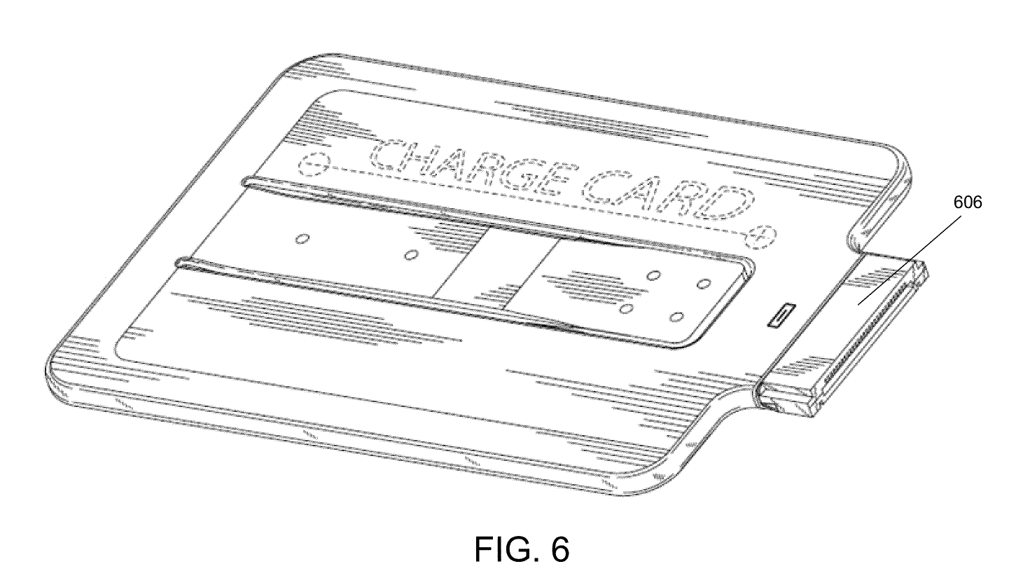

In some implementations, as depicted in FIG. 6, the first plug may be located near the middle of the second end of the portion and positioned such that the first plug extends outwardly from the second end at an angle parallel to the first and second edges of the body portion. In other implementations, as depicted in FIG. 1, the first plug may be located at a point along the second end of the body portion that is closer to the first edge than the second edge, and wherein the first plug extends outwardly from the point at an angle not parallel to the first and second edges of the body portion. FIG. 1 provides an example of this implementation, where the first plug 106 is located toward the distal edge 112 of the body portion 102 and extends from the body portion 102 at an angle that is not parallel to the angle of the distal 112 or proximal edges 114. This configuration may provide the added advantage of protecting the first plug from interfering with the wallet and from potentially breaking by getting caught on something when being stored or removed from the wallet.

The first set of contacts may be configured to be inserted into a receptacle of a first electronic device, which could be any mobile device that can be charged through a cable having the first set of contacts. As an example, the first electronic device could be a smartphone, a cell phone, a tablet, a personal digital assistant, a smart watch, a Bluetooth earphone, a GPS receiver, or the like. The first set of contacts could be any kind of mobile device connector, such as a micro-USB connector, a standard USB connector, or any similar standard used for mobile devices. As another example, the first set of contacts could be compatible with the Apple 30-pin port for the iPhone 4, or the Apple Lightning port for the iPhone 5 and iPad, or any other proprietary connector for a mobile device. In some implementations, the first plug may be thinner than a standard plug containing the first set of contacts. In these implementations, the first plug may be custom designed to be thinner to fit within the form factor of the data and charging cable. While the thinner first plug is different from the standard design, the first set of contacts of the plug is still configured to be inserted into the same receptacles of the first electronic devices. The advantage of this design is that it allows the data and charging cable to be thinner than if it used the standard plug design.

Some implementations of the claimed invention also include a second set of contacts located at the distal end of the elastomeric tongue.

Like the first set of contacts, the second set of contacts may be configured to be inserted into a receptacle of a second electronic device, which could be any powered electronic device having a receptacle that corresponds to the second set of contacts. In some implementations, the second set of contacts will be a USB connector, configured to fit into any standard USB port, which may be found in almost any location with electronic devices. In these implementations, the second plug may thinner than a standard plug containing the second set of contacts. For example, the USB connector may not include the full metal key, the typical metal housing that is found around most standard USB plugs, and it may not include grounding or shielding, so that the USB connector can be as thin as possible. In other implementations, the USB connector may include grounding and shielding and may provide some kind of metal housing for the USB connector, while maintaining the overall thinness of the connector. In other implementations, the second set of contacts may be any type of connector that is configured to be inserted into a port for charging or data syncing.

In some implementations, the thickness of the second plug is substantially the same as the thickness of the body portion. Since the second set of contacts is located at the end of the slot of the body portion and is located substantially within the body portion of the data and charging cable, having the second set of contacts and the body portion have substantially the same thickness makes the surface area of the charging cable relatively flat and easy to slip in and out of a wallet or purse sleeve.

In some implementations, the thickness of the second set of contacts may be the determining factor of how thin the data and charging cable can be, and the thickness of the body portion and thus the cable overall may depend on the what type of connector is used for the second set of contacts. As an example, if a standard USB connector without the metal key is used, the overall thickness of the data and charging cable may be about 2.6 mm.

Some implementations of the claimed invention also include a conductive path extending between the first set of contacts located at the second end of the body portion and the second set of contacts located at the distal end of the elastomeric tongue.

In some implementations, the conductive path may be a series of wires arranged in a flat configuration, extending down the elastomeric tongue and along the edge of the body portion to the first set of contacts. The flat configuration allows the elastomeric tongue to be as thin as practicably possible.

The conductive path may be configured to transfer data and electrical power between the first set of contacts and the second set of contacts. In other words, the cable may be used to charge the device that the first set of contacts is inserted into, or the cable may be used to sync data with the device.

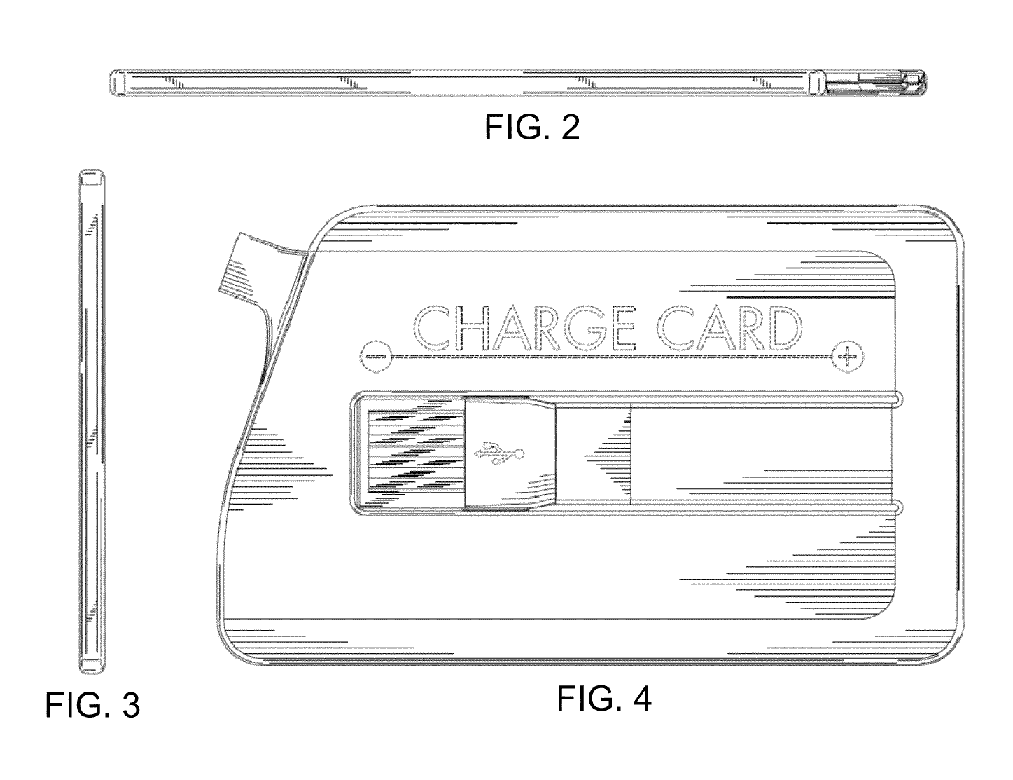

FIGS. 1-4 illustrate a credit card shaped charging and data cable, showing a first embodiment in a flat configuration. In FIG. 1, the charging and data cable has a body portion 102, and elastomeric tongue 104, a first plug 106 including a first set of contacts, a second plug 108 including a second set of contacts, and a conductive path 110 extending between the first set of contacts and the second set of contacts. The body portion 102 includes a first edge 112 and a second edge 114 on either side of the body portion 102. In this figure, the conductive path 110 is not visible, but runs under the elastomer overmold along the edge of the body portion 102. In the example of FIG. 1, the first plug 106 is a Micro USB connector, and the first plus 106 may be slightly thicker than the body portion 102. In other implementations of the invention, the first plug may be any kind of connector for a mobile device, such as an iPhone 5 connector.

FIG. 5 is a top perspective view of the first embodiment in a deployed configuration, wherein the elastomeric tongue 504 is unattached to the body portion 502 and may pivotably and flexibly bend outwards for the second set of contacts to be inserted into an electronic device with a matching receptacle. In the deployed configuration, the second set of contacts 508 may be inserted into the receptacle of the electronic device, and the first set of contacts 506 may be inserted into the receptacle of the mobile device to charge the mobile device or to sync data between the electronic device and the mobile device.

FIG. 6 is a top perspective view of a second embodiment of the credit card shaped charging and data cable, illustrated in a flat configuration. In this example, the first plug 606 is a different type of connector and is positioned in the middle of the end of the body portion of the data and charging cable.

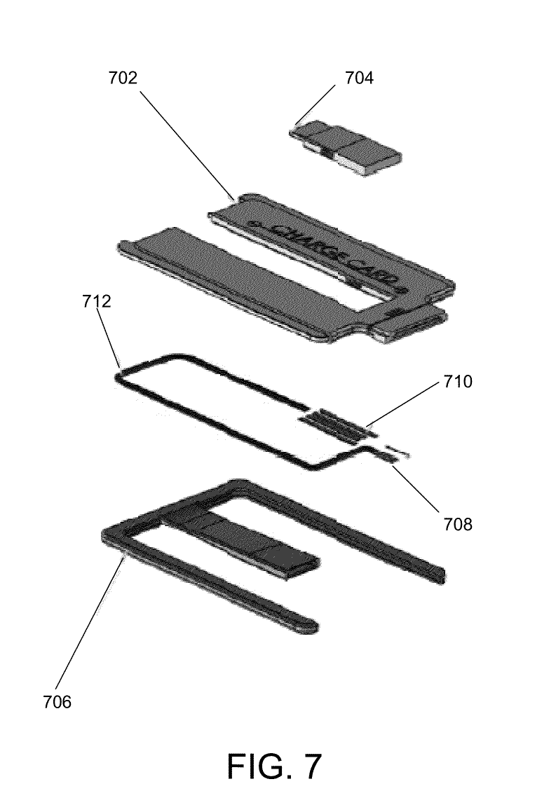

FIG. 7 presents an exploded view of the components of an embodiment of the credit card shaped data and charging cable. While FIG. 7 presents an overview of the components of the embodiment presented in FIG. 6, those skilled in the art will appreciate that an exploded view of the embodiment presented in FIG. 1 would be similar to the view presented in FIG. 7, with some differences in the shape of some of the components.

The embodiment presented in FIG. 7 includes the following components:
1. Hard plastic—Primary device connection (702)
2. Hard plastic—Secondary USB connection (704)
3. Flexible Elastomer Overmold (706)
4. Plated electrical contacts (device) (708)
5. Plated electrical contacts (USB) (710)
6. Wire grouping (712)

The wire grouping 712 is the soldered electrical connection between the Device 708 and USB 710 contacts, which allows power and data transfer. The device contacts 708 and a large section of wire grouping 712 are set into the matching recesses of the hard plastic primary 702. Similarly, the USB contacts 710 are set into the recesses in the hard plastic secondary 704. This creates two functional plugs, connected by wires and is, at this point, a functioning cable.

The two hard shells are assembled together, with the hard plastic secondary 704 snapping into the open area of the hard plastic primary 702. This configuration is held in place by two plastic detents on the edges of the secondary hard plastic assembly 704. A subsequent overmolding operation 706 then permanently unifies the two hard plastic sections, and creates a complete molded protection of the previously exposed wire grouping 712.

The secondary connection 704 created is in the form of a thin, flexible elastomer “tongue” which allows the USB hard plastic 704, when snapped out of place from the primary plastic body 702, to move with 4 degrees of freedom.

In some implementations, when USB plastic body 704 is set in place within the device connector plastic body 702, the cable is able to lay completely flat with few protruding edges and with a uniform thickness of less than 2.6 mm. This form factor, combined with the overall rigidity of the hard plastic primary 702 allows the cable to slip smoothly into a wallet or purses' card sleeve.

To operate the cable, the user unsnaps the USB plastic body 704 from the primary plastic body 702, which allows the USB plug assembly 704, 710 to move with 4 degrees of freedom; pitch, yaw, roll, and fore-aft translation. The user plugs the device connector 702, 708, 712 into a desired cell phone/portable device, and plugs the USB connector 704, 710 into an appropriate powered USB outlet. The shape of the primary hard plastic body 702, with its protruding plug that flares into the larger body, allows the plug to reach into the charge port of a device, even if the device is protected by a large case. This enables data transfer and charging via a 121 mm+/−38 mm long cable.

In some implementations, the cable may be used to transfer data between a first and second electronic device by performing the following method: (a) detaching the elastomeric tongue from the detent mechanism; and, in any order, (b) inserting the first set of contacts into the receptacle of the first electronic device; and (c) inserting the second set of contacts into the receptacle of the second electronic device; then (d) transferring data between the first and second electronic devices through the data cable.

In some implementations, the cable may be used to charge an electronic device by performing the following method: (a) detaching the elastomeric tongue from the detent mechanism of the charging cable; and, in any order, (b) inserting the first set of contacts into the receptacle of either the electronic device or charging device; and (c) inserting the second set of contacts into the receptacle of the other of the electronic device or charging device; then (d) providing electrical power to the electronic device from the charging device through the charging cable.

The devices of the invention may be made as plastic-over-cables assemblies. For example, the soldered cables and contacts 708, 710, 712 are set into a mold, and by way of a plastic injection overmold formed into the hard plastic primary 702 and secondary 704 sections. Alternatively, at lower temperatures and mold precision, the plastic primary 702 and plastic secondary 704 components are formed by sonically welding together two halves for each component. These halves would have molded cavities for receiving the electrical contacts 708, 710 and wire grouping 712 before being welded together.

The flexible elastomer 706 would be created by the following method: First, the secondary plastic body 704 is positioned within the primary plastic body 702, being located either by the molded detents, or small tabs attaching the secondary 704 to the primary 702 body. This group is then set into a mold, with the exposed wire group 712 being located by plastic tabs, steel pins, or another similar method. The elastomer is then molded over designated sections of the plastic primary 702 and plastic secondary 704 sections, as well as encasing the exposed section of the wire group 712. This operation unifies the two plastic sections, and encases all wires. Finally, any undesired plastic tabs, locating segments, or flash may be trimmed as required.

The use of a third material in the body may provide more variation for strength, flexibility, and durability. A small embedded battery may provide another level of mobile power.

The position of the USB 704 and device 702 connectors may be reversed, so the device connector becomes a subordinate element to the larger USB connector section. The size of each connector is completely variable, without compromising the fundamental function. The two sections can be connected by a thin flexible hinge, or a soft material which press fits together.

The card may be divided into any number of sections, as long as the collapsed form fits within the original size envelope of 2.5 mm+/−1.3 mm×83 mm+/−38 mm×51 mm+/−25 mm.

The basic form of this product can be used to power any portable electronic device, so long as the matching plug can be molded into the large body at a reasonable thinness, not disrupting the overall form factor.

While the invention has been particularly shown and described with reference to specific embodiments, it will also be understood by those skilled in the art that changes in the form and details of the disclosed embodiments may be made without departing from the spirit or scope of the invention. For example, the embodiments described above may be implemented using a variety of materials. Therefore, the scope of the invention should be determined with reference to the appended claims.

What is claimed is:

1. A data and charging cable, comprising:
a body portion having a form factor substantially like that of a credit card, the body portion including an upper surface and a lower surface, and a slot extending from proximal to a first end of the body portion along the length of the body portion toward a second end of the body portion and between the upper surface and the lower surface of the body portion;
an elastomeric tongue having a proximal end pivotably attached to the first end of the body portion and a distal end, the tongue sized to fit within the slot of the body portion and removably attached to the body portion by a detent mechanism, such that the tongue is movable through the slot from the upper surface to the lower surface of the body portion;
a first plug including a first set of contacts located at the second end of the body portion, the first set of contacts configured to be inserted into a receptacle of a first electronic device;
a second plug including a second set of contacts located at the distal end of the elastomeric tongue, the second set of contacts configured to be inserted into a receptacle of a second electronic device; and
a conductive path extending between the first set of contacts located at the second end of the body portion and the second set of contacts located at the distal end of the elastomeric tongue, the conductive path configured to transfer data and electrical power between the first set of contacts and the second set of contacts.

2. The data and charging cable of claim 1, wherein the thickness of the body portion does not exceed about 2.6 millimeters.

3. The data and charging cable of claim 1, wherein the body portion has a form factor smaller than 121 mm×76 mm×3.8 mm.

4. The data and charging cable of claim 1, wherein the body portion has uniform thickness.

5. The data and charging cable of claim 1, the body portion having tapered edges, wherein the thickness of the body portion decreases from a first point proximal to the center of the body portion toward a second point proximal to an edge of the body portion.

6. The data and charging cable of claim 1, wherein the first plug and the first set of contacts are formed as an integral part of the body portion to extend outwardly from the second end of the body portion.

7. The data and charging cable of claim 6, the body portion having a first edge and a second edge opposite the first edge, wherein the first plug is located at a point along the second end of the body portion, the point being closer to the first edge than the second edge, and wherein the first plug extends outwardly from the point at an angle not parallel to the first and second edges of the body portion.

8. The data and charging cable of claim 6, wherein the first plug is slightly thicker than the body portion.

9. The data and charging cable of claim 6, wherein the first plug has a thickness that is substantially the same as the thickness of the body portion.

10. The data and charging cable of claim 6, wherein the first plug is thinner than a standard plug containing the first set of contacts and is adapted to fit into the receptacle of the first electronic device.

11. The data and charging cable of claim 1, wherein the second plug is thinner than a standard plug containing the second set of contacts and is adapted to fit into the receptacle of the second electronic device.

12. The data and charging cable of claim 1, wherein the first set of contacts is one of: a mobile device connector, a Micro-USB connector, or similar standard used for mobile devices.

13. The data and charging cable of claim 1, wherein the second set of contacts is a USB connector having a thickness that is substantially the same as the thickness of the body portion.

14. The data and charging cable of claim 1, wherein the first electronic device is a mobile device, the mobile device being one of: a cell phone, a smartphone, a tablet, a personal digital assistant, a smart watch, a Bluetooth earphone, and a GPS receiver.

15. The data and charging cable of claim 1, wherein the second electronic device is a powered electronic device with a charging port.

16. The data and charging cable of claim 1, wherein the elastomeric tongue is configured to move with four degrees of freedom, including pitch, yaw, roll, and fore-aft translation.

17. The data and charging cable of claim 1, wherein the elastomeric tongue is configured to move with two degrees of freedom, including pitch and fore-aft translation.

18. The data and charging cable of claim 1, wherein the data and charging cable is configured to synchronize data between the first electronic device and the second electronic device and to charge the first electronic device using electrical power from the second electronic device.

19. The data and charging cable of claim 1, wherein the body portion does not include a battery.

20. A data and charging cable, comprising:
a body portion having a form factor substantially like that of a credit card, the body portion including an upper surface and a lower surface, and a slot extending from proximal to first end of the body portion partially down the length of the body portion toward a second end of the body portion and between the upper surface and the lower surface of the body portion;
an elastomeric tongue having a proximal end pivotably attached to the first end of the body portion and a distal end, the tongue sized to fit within the slot of the body portion and removably attached to the body portion by a detent mechanism, wherein the elastomeric tongue is configured to move with four degrees of freedom, including pitch, yaw, roll, and fore-aft translation;
a first plug including a first set of contacts located at the second end of the body portion, the first plug formed as an integral part of the body portion to extend outwardly from the second end of the body portion, the first set of contacts configured to be inserted into a receptacle of a first electronic device;
a second plug including a second set of contacts located at the distal end of the elastomeric tongue, the second set of contacts configured to be inserted into a receptacle of a second electronic device; and
a conductive path extending between the first set of contacts and the second set of contacts, the conductive path configured to transfer data and electrical power between the first set of contacts and the second set of contacts.

21. The data and charging cable of claim 20, wherein the thickness of the body portion does not exceed about 2.6 millimeters.

22. The data and charging cable of claim 20, wherein the body portion has a form factor smaller than 121 mm×76 mm×3.8 mm.

23. The data and charging cable of claim 20, wherein the body portion has uniform thickness.

24. The data and charging cable of claim 20, the body portion having tapered edges, wherein the thickness of the body portion decreases from a first point proximal to the center of the body portion toward a second point proximal to an edge of the body portion.

25. The data and charging cable of claim 24, the body portion having a first edge and a second edge opposite the first edge, wherein the first plug is located at a point along the second end of the body portion, the point being closer to the first edge than the second edge, and wherein the first plug extends outwardly from the point at an angle not parallel to the first and second edges of the body portion.

26. The data and charging cable of claim 24, wherein the first plug is slightly thicker than the body portion.

27. The data and charging cable of claim 24, wherein the first plug has a thickness that is substantially the same as the thickness of the body portion.

28. The data and charging cable of claim 24, wherein the first plug is thinner than a standard plug containing the first set of contacts and is adapted to fit into the receptacle of the first electronic device.

29. The data and charging cable of claim 20, wherein the second plug is thinner than a standard plug containing the second set of contacts and is adapted to fit into the receptacle of the second electronic device.

30. The data and charging cable of claim 20, wherein the first set of contacts is one of: a mobile device connector, a Micro-USB connector, or similar standard used for mobile devices.

31. The data and charging cable of claim 20, wherein the second set of contacts is a USB connector having a thickness that is substantially the same as the thickness of the body portion.

32. The data and charging cable of claim 20, wherein the first electronic device is a mobile device, the mobile device being one of: a cell phone, a smartphone, a tablet, a personal digital assistant, a smart watch, a Bluetooth earphone, and a GPS receiver.

33. The data and charging cable of claim 20, wherein the second electronic device is a powered electronic device with a charging port.

34. The data and charging cable of claim 20, wherein the data and charging cable is configured to synchronize data between the first electronic device and the second electronic device and to charge the first electronic device using electrical power from the second electronic device.

35. The data and charging cable of claim 20, wherein the body portion does not include a battery.

36. A method of transferring data between a first and a second electronic device, comprising:
(a) detaching an elastomeric tongue from a detent mechanism on a data cable comprising:
a body portion having a form factor substantially like that of a credit card, the body portion including an upper surface and a lower surface, and a slot extending from proximal to a first end of the body portion along the length of the body portion toward a second end of the body portion and between the upper surface and the lower surface of the body portion;
said elastomeric tongue having a proximal end pivotably attached to the first end of the body portion and a distal end, the tongue sized to fit within the slot of the body portion and removably attached to the body portion by said detent mechanism, such that the tongue is movable through the slot from the upper surface to the lower surface of the body portion;
a first plug including a first set of contacts located at the second end of the body portion, the first set of contacts configured to be inserted into a receptacle of the first electronic device;
a second plug including a second set of contacts located at the distal end of the elastomeric tongue, the second set of contacts configured to be inserted into a receptacle of the second electronic device; and
a conductive path extending between the first set of contacts and the second set of contacts, the conductive path configured to transfer data between the first set of contacts and the second set of contacts; and, in any order,
(b) inserting the first set of contacts into the receptacle of the first electronic device; and
(c) inserting the second set of contacts into the receptacle of the second electronic device; then
(d) transferring data between the first and second electronic devices through the data cable.

37. A method of electrically charging an electronic device, comprising:
(a) detaching an elastomeric tongue from a detent mechanism on a charging cable comprising:
a body portion having a form factor substantially like that of a credit card, the body portion including an upper surface and a lower surface, and a slot extending from proximal to a first end of the body portion along the length of the body portion toward a second end of the body portion and between the upper surface and the lower surface of the body portion;
said elastomeric tongue having a proximal end pivotably attached to the first end of the body portion and a distal end, the tongue sized to fit within the slot of the body portion and removably attached to the body portion by said detent mechanism, such that the tongue is movable through the slot from the upper surface to the lower surface of the body portion;
a first plug including a first set of contacts located at the second end of the body portion, the first set of contacts configured to be inserted into a receptacle of the electronic device or a charging device;
a second plug including a second set of contacts located at the distal end of the elastomeric tongue, the second set of contacts configured to be inserted into a receptacle of the electronic device or a charging device; and
a conductive path extending between the first set of contacts and the second set of contacts, the conductive path configured to transfer electrical power between the first set of contacts and the second set of contacts; and, in any order,
(b) inserting the first set of contacts into the receptacle of either the electronic device or charging device; and
(c) inserting the second set of contacts into the receptacle of the other of the electronic device or charging device; then
(d) providing electrical power to the electronic device from the charging device through the charging cable.
